(19) United States
(12) Patent Application Publication
(10) Pub. No.: US 2002/0077063 A1
(43) Pub. Date: Jun. 20, 2002

(54) Contactless data transmission system

(75) Inventor: Dieter Ansel, Heilbronn (DE)

Correspondence Address: FASSE PATENT ATTORNEYS, P.A., P.O. BOX 726, HAMPDEN, ME, 04444-0726, US

(73) Assignee: ATMEL Germany GmbH, Heilbronn (DE)

(21) Appl. No.: 10/017,309

(22) Filed: Dec. 14, 2001

(30) Foreign Application Priority Data
Dec. 16, 2000 (DE) 100 62 924.5

(51) Int. Cl. H04B 5/00

(52) U.S. Cl. 455/41; 455/421

(57) ABSTRACT

1. Contactless data transmission system

2.1. Contactless data transmission systems in which initially, through inductive coupling, power transmission takes place have unchangeable security properties that define the reaction speed and the range of such systems.

2.2. On the data transmission system there is a switch or a control line with the help of which the input data format can be modified subsequently.

2.3. A contactiess data transmission system of this kind makes it possible to subsequently adapt to the purpose of application for a wide variety of applications with different requirements in terms of security, reaction speed and range.

### BACKGROUND OF THE INVENTION

The invention relates to a contactless data transmission system in accordance with the preamble of Patent claim 1.

For the transmission of encoded electronic data, data transmission systems are commonly used comprising a battery operated (IR/HF) remote control as transmitter module and a suitable receiver module. Furthermore, data transmission systems consisting of a transponder and a reader are also used in which initially by means of an inductive coupling power transmission takes place between reader and transponder and subsequently data transmission between transponder (transmitter) and reader (receiver). Data transmission systems of this kind are available on the market, especially in the field of motor vehicles, as a combination of electronic key (transponder) and electronic lock (reader) for the purpose of operating lock systems and antitheft devices in the form of immobilizers.

Data transmission in the RF range (typically 100 kHz to 450 kHz) between the transponder, which essentially consists of an integrated circuit (IC) and a coil, and the reader can take place in several ways.

Either unidirectionally by means of a fixed-code transponder which transfers as password each time readout takes place (each time data is transmitted) a fixed code stored in a programmable read-only memory (PROM) of the IC or bidirectionally by means of a read/write transponder which transfers as password each time readout takes place (each time data is transmitted) a variable code stored in a read/write memory (EEPROM) of the IC and after successful authorization from the reader receives a new code and enters this in the EEPROM. As an additional measure for enhancing security, not only are ciphering methods adopted but also algorithms are used to verify that the transponder and base station belong together. The following sequence results:

the base station generates an electromagnetic field;

this causes the transponder to be activated;

the transponder sends its identification number to the base station;

the base station checks the correctness of the identification number and generates a base station random number;

the base station random number is ciphered in the base station;

the ciphered base station random number is sent to the transponder where it is deciphered and thereby generates a transponder random number;

this transponder random number or a value dependent on the transponder random number is sent to the base station where it is checked for its correctness;

this transponder or base station random number is the input value for an algorithm that includes a variable which exists both in the base station and in the transponder, unique values being assigned to the variable of the algorithm through a secret code thus generating a transponder result in the transponder and a base station result in the base station.

The transponder result is sent to the base station.

Transponder result and base station result are compared in the base station.

In such a sequence, identical results from transponder and base station can be obtained only when the secret code, the algorithm, the random number and the cipher in the two components are identical or at least known by the other component.

The security and also the reaction speed of such a data transmission system depends among other factors on the format of the random number, and especially on the number of bits that make up the random number.

It is however disadvantageous here that the security and possibly the range and the reaction speed of a contactless data transmission system containing an algorithm for encoding cannot be modified.

### SUMMARY OF THE INVENTION

The object of the invention is to provide a contactless data transmission system in which the reaction speed, the range and security can be subsequently modified, in particular depending on the application.

The object of the invention has been solved by the features described in Patent claim 1. The data transmission system here has at least one device with which the various input data formats for the encoding algorithm are set. The device can consist of one or several additional hardware terminal connections or terminal connection assignments and switches or it can consist of one or several additional control signals that determine the input data format.

The advantages of the invention are that it is no longer necessary to have different data transmission systems for different applications, instead identical data transmission systems can be used for different applications with different requirements. Also, the properties of such data transmission systems can be set individually for one and the same application.

Advantageous further developments result from the subclaims where one and the same encoding algorithm is used for the various input data formats. Another advantageous further development results from the retention of the secret code irrespective of the input data format.

### BRIEF DESCRIPTION OF THE DRAWINGS

The invention will now be described in more detail with reference to two examples of embodiment and figures. These show:

FIG. 1: Encoding block

FIG. 2a: Function block of the 32 bit encoding algorithm

FIG. 2b: Function block of the 64 bit encoding algorithm

FIG. 3: Effect of function f in the encoding algorithm

FIG. 4: Data transmission system

### DESCRIPTION OF THE PREFERRED EMBODIMENTS

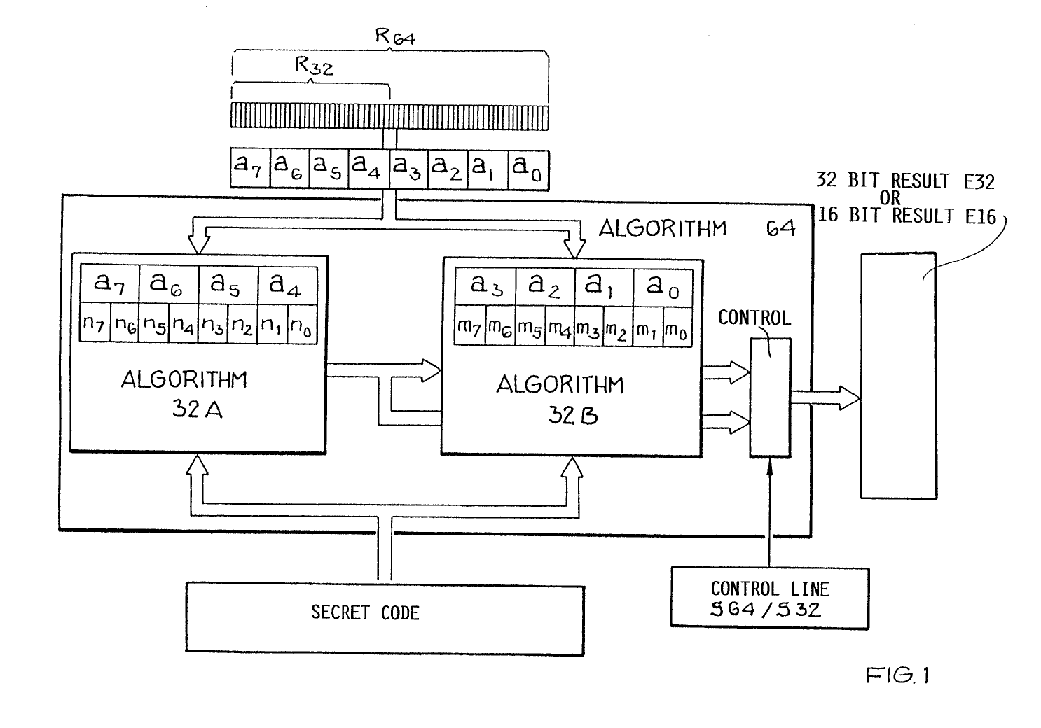

FIG. 1 shows the encoding block. With a 64-bit input data format the random number R₆₄ which has this format is first converted into a first variant R₈ which consists of 8 bytes: a₇, a₆, a₅, a₄, a₃, a₂, a₁, a₀, where in turn each byte is made up of 8 bits. These 8 bytes are the input data for the encoding algorithm A64 with which a 64 bit random number can be processed. In the application example, the encoding algorithm A64 is made up of two components, namely A32A and A32B, where each component processes 32 bits. Of the two components of A64, at least one represents an independent encoding algorithm with which a calculation can be performed without consideration of the other part. The A64 algorithm serves to process a random number with 64-bit format and the A32A and A32B each serve to process a 32-bit format. When processing the 8 bytes, the first 4 bytes a7, a6, a5, a4 are supplied to the component A32A and the other 4 bytes a3, a2, a1, a0 to A32B. Subsequently, 8 nibbles n₇, n₆, n₅, n₄, n₃, n₂, n₁, n₀ and m₇, m₆, m₅, m₄, m₃, m₂, m₁, m₀ are assigned to the 4 bytes a₇, a₆, a₅, a₄ und a₃, a₂, a₁, a₀ in A32A and A32B respectively. Each nibble consists of 4 bits. The algorithm and its components include variables. These variables are assigned unique values by means of a 120 bit secret code. This secret code contains the key data which is used for A64 as well as for A32A and A32B. They are supplied to the encoding algorithm A64 from the outside. The encoding algorithm and the secret code must be selected such that they can be used for random numbers or random number variants with different formats. In the application example, this means for a random number or a random number variant with a format of:

64 bits or 16 nibbles or 8 bytes or

32 bits or 8 nibbles or 4 bytes.

Furthermore, the encoding block has a control line with which the format of the random number or the random number variant can be selected by means of a control unit CONTROL. If a 64 bit format is selected via the control line S64/32, the encoding algorithm A64 is activated with its two components A32A and A32B. The result E₃₂ at the output then has, for example, a 32 bit format. If, however, a 32 bit format is selected for the random number or random number variant via the control line S64/32, only the encoding algorithm A32A is active. The result E,₁₆ at the output then has a 16 bit format. The calculation times are shorter for the smaller format and require less power.

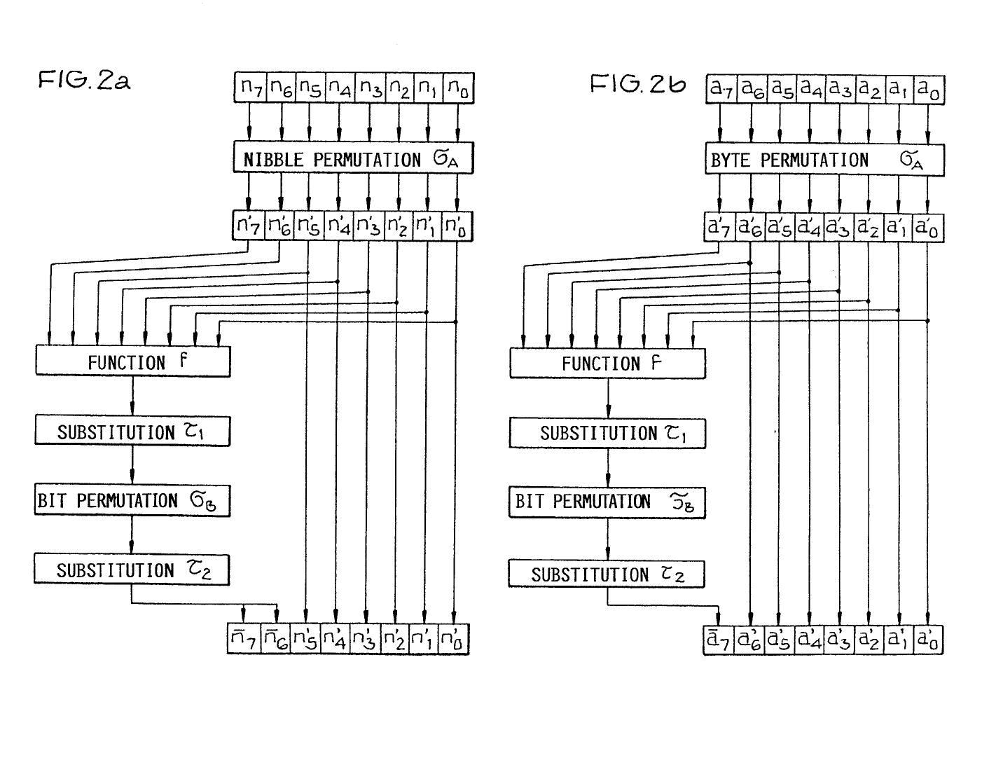

FIG. 2a shows the function block of the 32 bit encoding algorithm A32A. This is a nibble-oriented encoding which is generated from 32 bits of a random number R₃₂ with at least a 32 bit format and which uses, for example, a 120 bit format secret code. By means of this secret code, the nibble permutation σ_{A}, the function f, the first substitution τₗ, the bit permutation σ_{B} and the second substitution τ₂ can be defined uniquely. Both the two permutations σ_{A}, σ_{B} and also the two substitutions can be identical here, so that σ_{A}=σ_{B} and/or τ₁=τ₂. At the beginning eight nibbles n₇, n₆, n₅, n₄, n₃, n₂, n₁, n₀, the components of the random number and each consisting of 4 bits, are permutated with σ_{A} and eight new nibbles n′₇, n′₆, n′₅, n′₄, n′₃, n′₂, n′₁, n′₀ are generated. After this, these eight nibbles n′₇, n′₆, n′₅, n₄, n′₃, n′₂, n′₁, n′₀ are supplied to a function f. Then the function result is subjected to a first substitution τ₁ after which a further bit permutation σ_{B} is performed. Finally, a second substitution τ₂ takes place. This result serves to exchange the nibbles n′₇ und n′₆so that a new value with \overline{n}₇, \overline{n}₆ , n′₅, n′₄, n′₃, n′₂, n′₁, n′₀ is created. This encoding process with the operations described above runs in a loop with, for example, 24 rounds.

FIG. 2b shows the function block of the 64 bit encoding algorithm A64. This is a byte-oriented coding generated from a 64 bit random number R₆₄ and which uses, for instance, a 120 bit format secret code. By means of this secret code, the byte permutation σ_{A}, the function f, the first substitution τ₁, the bit permutation σ_{B} and the second substitution τ₂ are defined. The two permutations σ_{A}, σ_{B} and the two substitutions here can be identical so that σ_{A}=σ_{B} and/or τ₁=τ₂.

At the beginning eight bytes a₇, a₆,a₅,a₄, a₃, a₂,a₁, a₀, provided by the random number and each consisting of 8 bits, are permutated with σ_{A} and eight new bytes a′₇, a′₆, a′₅, a′₄, a′₃, a′₂, a′₂, a′₁, a′₀ are generated, After this, these eight bytes a′₇,a′₆,a′₅,a′₄, a′₃, a′₂, a′₁, a′₀ are supplied to a function f. Then the function result is subjected to a first substitution τ₁ after which a further bit permutation σ_{B} is performed. Finally, a second substitution τ₂ takes place.

This result serves to exchange the byte a′₇ so that a new value with \overline{a}₇, a′₆, a′₅, a′₄, a′₃, a′₂, a′₁,a′₀ is created. This encoding process with the operations described above runs in a loop with, for example, 24 rounds.

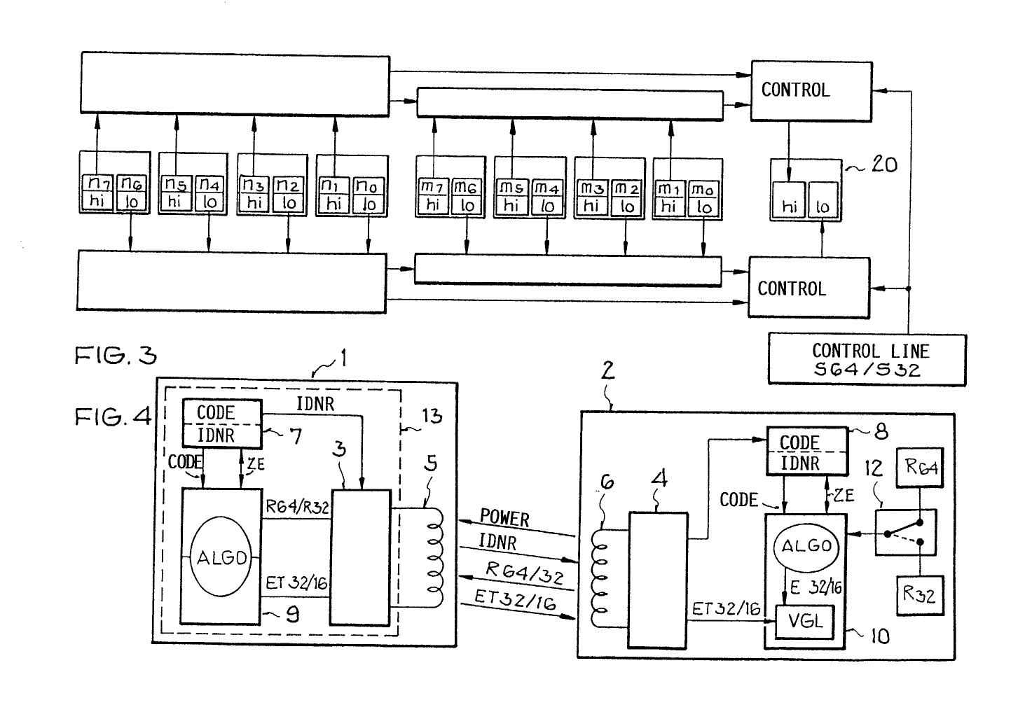

FIG. 3 shows how function f operates for the 32 and 64 bit encoding algorithm. Function f is structured such that it can work with different input data widths. The input data width can be reduced from 64 bits or 8 bytes (a ₇, a₆ , a₅, a₄, a₃, a₂, a₁, a₀ ) or 16 nibbles (n₇, n₆ , n₅, n₄, n₃ , n₂, n₁, n₀, m₇, m₆, m₅, m₄, m₃, m₂, m₁, m₀) to 32 bits or 4 bytes (a₇, a₆, a₅, a₄) or 8 nibbles (n₇, n₆, n₅, n₄, n₃, n₂, n₁, n₀). In the application example, four bits hi, lo for example are then assigned to each nibble. Then a logic operation is performed on all four-element bits hi, which have originated from the odd-numbered nibbles n₇, n₅, n₃, n₁[m₇, m₅,m₃, m₁], generating a 4 bit result hi irrespective of the number of nibbles. The same happens with the four-element bits lo, which have originated from the even-numbered nibbles n₆, n₄, n₂, n₀[m₆, m₄, m₂, m₀]. The end result 20 of the function f then always has two nibbles or two four-element bits hi, lo irrespective of whether the n and m nibbles or the n nibbles alone have generated the 2-nibble result 20. This Figure is intended to illustrate that in the selection of the 64 bit encoding algorithm both blocks can be activated and in the selection of the 32 bit algorithm only the first block is used, where the same secret code can be used at all times with the same key data for the function f of the algorithm. Furthermore, the result that this function f supplies from FIGS. 2a and 2b always has the same format irrespective of the input data format. In this Figure, the control devices CONTROL, whose inputs are linked with the even and odd numbered nibble operations and whose output signals generate the result 20, are influenced by the control line S64/32. In this application example, a control line should be understood to mean a line or connection in which, for example, programmable control signals are transferred that influence in software terms the calculation process or the device settings.

FIG. 4 shows the data transmission system for variable data formats. The data transmission system has a transponder 1 and a reader 2. The transponder I has a transponder coil 5, for power and data transmission, and an integrated circuit (IC) 13. The IC 13 has a transponder control unit 3 for the power supply and sequence control, a memory unit 7 in which the identification number IDNR and the secret CODE are stored; likewise, intermediate results ZE can be stored here and an encoding/decoding/calculation unit 9 for generating the transponder result E_{T64/32} with the help of the reader's random number R₆₄, R₃₂, which is required as input value for the algorithm A64.

The reader 2 consists of a coil 6, used for both power transmission and data transmission, the control unit 4 for sequence control, the memory unit 8 for storing the identification number IDNR and the secret CODE, and the encoding/decoding/calculation unit 10 for generating the reader result E_{L64/32} with the help of the reader's random number R₆₄, R₃₂, which is required as input value for the algorithm A64. Furthermore, the arrangement includes an electric, electronic, optical or mechanical switch 12, or alternatively a control line as shown in the preceding Figures with which the format of the random number R₆₄ or R₃₂ is selected.

After activation of the reader 2 - for instance, for a motor vehicle by operating the door handle or by switching on the ignition—power is transmitted from the coil 6 of the reader 2 to the coil 5 of the transponder 1. This process is shown in the drawing by the arrow marked POWER between reader 2 and transponder 1. The identification number IDNR, which is stored in the memory unit 7 of transponder 1, is then sent via the control unit 3 to the reader 2. Transmission of the identification number is indicated by an arrow with the designation IDNR between transponder 1 and reader 2. The identification number IDNR is verified in the reader 2. A reader random number R₆₄/R₃₂ is then generated in the reader 2. The format of the random number R₆₄/R₃₂ depends on the position of the switch 12. The random number has either a 64 bit format R₆₄ or a 32 bit format R₃₂. This random number R₆₄/R₃₂ is sent in encoded form to the transponder 1. The random number R₆₄/R₃₂ is decoded in the device 9. The reader random number R₆₄/R₃₂ and the transponder random number R₆₄/R₃₂ should be identical in the application example. They provide the input data for the calculation with the reader algorithm A64 and similarly with the transponder algorithm A64. In the application example, the transponder algorithm and the reader algorithm are identical and with identical secret CODE and identical random number R₆₄/R₃₂ as input variable they generate an identical end result E_{T32/16}, E_{L32/16} with 32 bit format and 16 bit format respectively. To enhance security, intermediate results ZE are generated during calculation. The intermediate result is then used as new input value for the algorithm which then repeats the calculations over several rounds with the constantly changing intermediate results until the end result is obtained after, for example, 24 rounds. The transponder result E_{T32/16} is then sent to the reader 2 where it is compared in a comparator VGL with the reader result calculated in the reader 2.

The selection of the input data width, i.e. the selection as to whether a 64 bit random number R₆₄ or a 32 bit random number R₃₂ is selected, can take place not only by means of a switch 12, as shown in this Figure, but also by means of a programmable control line S64/32 as portrayed in FIGS. 1 and 3.

By changing over the input data format for the algorithm, the data sets to be transmitted and hence the power requirement too can be reduced and the reaction speed and range can be increased. With such a data transmission system, it is therefore possible for security steps to be programmed or set by means of a switch thus allowing subsequent adaptation of the specifications of the data transmission system to satisfy particular requirements.

Data transmission systems of this kind with variable input data format for an encoding algorithm can be used not only for transponder systems but for all wireless transmission systems, especially electromagnetic, optical and high-frequency systems.

What is claimed is:

1) Contactless data transmission system with
an encoding algorithm (A64) with which
the input data (R₆₄, R₃₂), which are processed with the encoding algorithm (A64), are linked with
a secret code (CODE) that determines the encoding algorithm (A64),
wherein the data transmission system has a facility (12, S64/S32) for setting to different formats of the input data (R₆₄, R₃₂) for the encoding algorithm (A64).

2) Contactless data transmission system in accordance with Patent claim 1, wherein the facility for setting to different formats of the input data (R₆₄, R₃₂) is a control line (S64/S32).

3) Contactless data transmission system in accordance with Patent claim 1, wherein the facility for setting to different formats of the input data (R₆₄, R₃₂) is a switch (12).

4) Method for a contactless data transmission system in accordance with Patent claim 1, wherein the same encoding algorithm (A64) is used for the various formats of the input data (R₆₄, R₃₂).

5) Method for a contactless data transmission system in accordance with Patent claim 2, wherein the same encoding algorithm (A64) is used for the various formats of the input data (R₆₄, R₃₂).

6) Method for a contactless data transmission system in accordance with Patent claim 3, wherein the same encoding algorithm (A64) is used for the various formats of the input data (R₆₄, R₃₂).

7) Method for a contactless data transmission system in accordance with Patent claim 1, wherein the same secret code (CODE) is used for the various formats of the input data (R₆₄, R₃₂).

8) Method for a contactless data transmission system in accordance with Patent claim 2, wherein the same secret code (CODE) is used for the various formats of the input data (R₆₄, R₃₂).

9) Method for a contactless data transmission system in accordance with Patent claim 3, wherein the same secret code (CODE) is used for the various formats of the input data (R₆₄, R₃₂).

10) Method for a contactless data transmission system in accordance with Patent claim 4, wherein the same secret code (CODE) is used for the various formats of the input data (R₆₄, R₃₂).
